(19) United States
(12) Patent Application Publication
(10) Pub. No.: US 2015/0372279 A1
(43) Pub. Date: Dec. 24, 2015

(54) ACTIVE BATTERY STACK SYSTEM AND METHOD

(71) Applicant: Turboroto Inc., Saratoga, CA (US)

(72) Inventor: Ping Li, Saratoga, CA (US)

(21) Appl. No.: 14/748,092

(22) Filed: Jun. 23, 2015

Related U.S. Application Data
(60) Provisional application No. 62/016,619, filed on Jun. 24, 2014.

(51) Int. Cl. H01M 2/20; H01M 10/0525; H02J 7/00; H01M 10/30; H01M 10/32; H01M 10/054; H01M 10/42; H01M 10/06

(52) U.S. Cl. CPC H01M 2/202; H01M 10/425; H01M 10/0525; H01M 10/06; H01M 10/30; H01M 10/32; H01M 10/054; H01M 2/204; H01M 2/206; H02J 7/0063; H01M 2010/4271; H01M 2220/20; H01M 2220/30; H01M 2220/10; H01M 2010/4278

(57) ABSTRACT

An active battery stack DC power conversion and energy storage system and method is disclosed herein. “Active” battery stack shall mean battery modules (e.g., having a least one of or a plurality of energy storage batteries) which can be engaged or disengaged as opposed to “passive” battery stacks in which the battery stack is hardwired and the batteries cannot be separated. Any battery energy storage application can benefit from this active battery management system and method for the flexibility to engage and disengage an individual battery in the battery stack regardless of whether it is charging, discharging or for maintenance purposes.

### CROSS REFERENCE TO RELATED APPLICATIONS

This application claims the priority benefit of U.S. Provisional Patent Application No. 62/016,619, titled “Active Battery Management System and Method” and filed on Jun. 24, 2014; the entire contents of this application are incorporated herein by reference.

### FIELD OF THE DISCLOSURE

This invention is in the field of energy storage systems and methods.

### BACKGROUND

Alternating Current (AC) power transmission is the dominate method of transmitting electric energy for its ease of line voltage conversion. However, Direct Current (DC) has the advantages of less transmission loss and twice the power capacity for the same three conductor transmission line. One problem with DC transmission is the cost of DC voltage conversion technology. Therefore, high voltage DC power transmission is typically used in extreme situations like under sea electric transmissions, high power long distance land transmission line, or bridging a mega AC utility power grid. Metropolitan underground AC power line loss can be greatly reduced with Direct Current instead of Alternating Current if solid state semiconductor technology can be adapted to handle the DC voltage conversion process which currently is only able to handle a few thousand volts of electric potential. One of today's power transmission challenges is real time generation and real time consuming since the utility power grid does not have active instant backup capability.

### SUMMARY

Aspects of the embodiments disclosed here include an Active Battery Stack (ABS) Direct Current (DC) energy storage system, comprising: a plurality of energy storage batteries in a battery stack; and at least one Electrical Connection Device(ECD) coupled to at least one of the plurality of Energy Storage Batteries(ESB), wherein the at least one ECD comprises a first switch serially connected with the at least one of the plurality of energy storage batteries and a second switch connected in parallel with both of the at least one of the plurality of energy storage batteries and the first switch.

Further aspects of the embodiments disclosed herein include a method to build up a battery stack with a variable stack voltage by engaging and disengaging a plurality of energy storage battery (ESB) modules.

Further aspects of the embodiments disclosed herein include a method in a battery stack to use a plurality of energy storage battery (ESB) modules as voltage dividers to divide a high voltage direct current (HVDC) input into lower predetermined voltage outputs.

Further aspects of the embodiments disclosed herein include a method to build variable incremental battery stack voltage in an active battery stack (ABS) Direct Current (DC) energy storage system to provide Direct Drive DC current to an electric load, such as an electric traction motor, the method comprising: engaging and disengaging a plurality of energy storage battery modules; and wherein each of said energy storage battery modules includes a plurality of energy storage batteries in a battery stack and at least one electrical connection device coupled to at least one of the plurality of energy storage batteries, said at least one electrical connection device engaging and disengaging the plurality of energy storage battery modules by closing and opening a first switch and a second switch in the at least one electrical connection device, wherein the first switch is serially connected to at least one of the plurality of energy storage batteries and the second switch is in parallel with the first switch.

Further aspects of the embodiments disclosed herein include a method to enable a direct current (DC)/DC power conversion for a first DC power source to a second power source and energy storage system comprising: engaging at least one of a plurality of energy storage battery modules having a plurality of energy storage batteries to build up an active battery stack voltage to substantially match the first DC power source voltage; converting the first DC power source voltage to a second DC power with a DC power conversion system; and disengaging at least one of the plurality of energy storage battery modules to regulate an active battery stack charging current.

### BRIEF DESCRIPTION OF THE DRAWINGS

FIG. 1 shows an embodiment 100 of an Active Battery Stack (ABS) connected to a charging power source 104.

FIGS. 2A and 2B show details of an exemplary Energy Storage Battery (ESB) modules 102 for use in the ABS 100.

FIGS. 3A-3C show operation of energy storage battery module 102 under charging conditions

FIGS. 4A-4C show operation of energy storage battery module 102 under discharging conditions

FIG. 5 shows typical lithium battery voltage characteristics verses charged capacity.

FIG. 6 is a diagram of an another exemplary implementation of an active battery stack 600 for High Voltage Direct Current conversion.

FIG. 7 is a diagram of an another exemplary implementation of an active battery stack 700 embodiment of an active battery stack with variety multiple modules for an electric vehicle application.

FIG. 8 is a diagram of an exemplary implementation of an ABS.

FIG. 9 illustrates an exemplary embodiment to utilize the ABS 700 as a Power on Demand Direct Drive for an electric vehicle DC traction motor.

FIG. 10 shows the active battery stack in an electric vehicle application.

FIG. 11 illustrates the active battery stack in a High Voltage DC transmission application.

### DETAILED DESCRIPTION

Disclosed herein is an active battery stack DC power conversion and energy storage system and method. “Active” battery stack (ABS) 100 as used herein means that serially connected energy storage battery (ESB) modules 102 in the battery stack can be engaged or disengaged from the battery stack as opposed to a “passive” battery stack in which the serially connected batteries are hardwired and cannot be easily separated. Any battery energy storage application can benefit from this ABS 100 for the flexibility to engage and disengage battery modules 102 in the active battery stack regardless of whether the stack is charging, discharging or for maintenance purposes. By engaging and disengaging using an Electric Conversion Device (ECD) 207 typically located in the ESB modules as described in detail herein the stack voltage of an active battery stack 100 can be varied as desired. This allows a variable voltage supply, for example, to drive a traction motor or build up stack voltage to power transmission lines to divide high voltage into manageable modular level voltages.

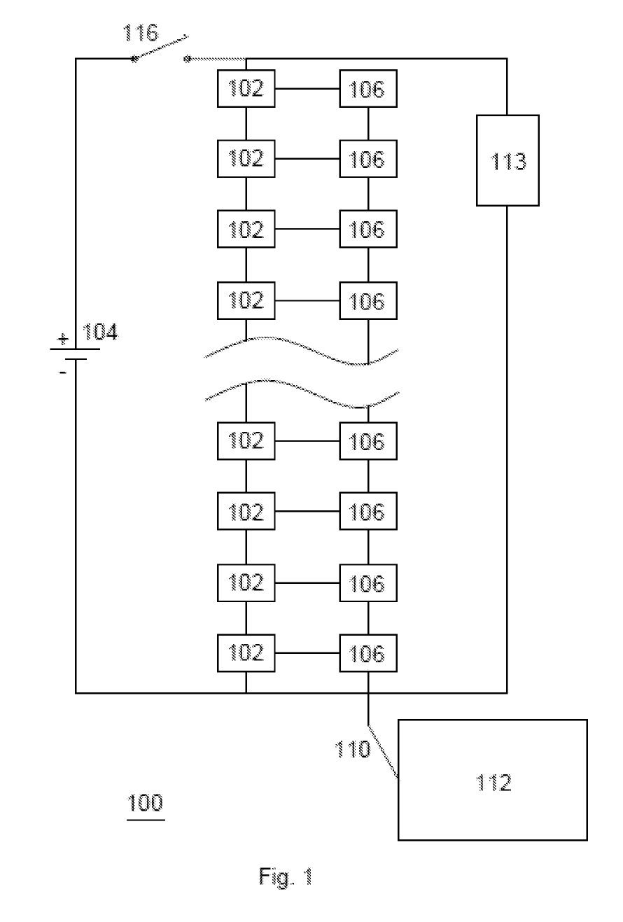

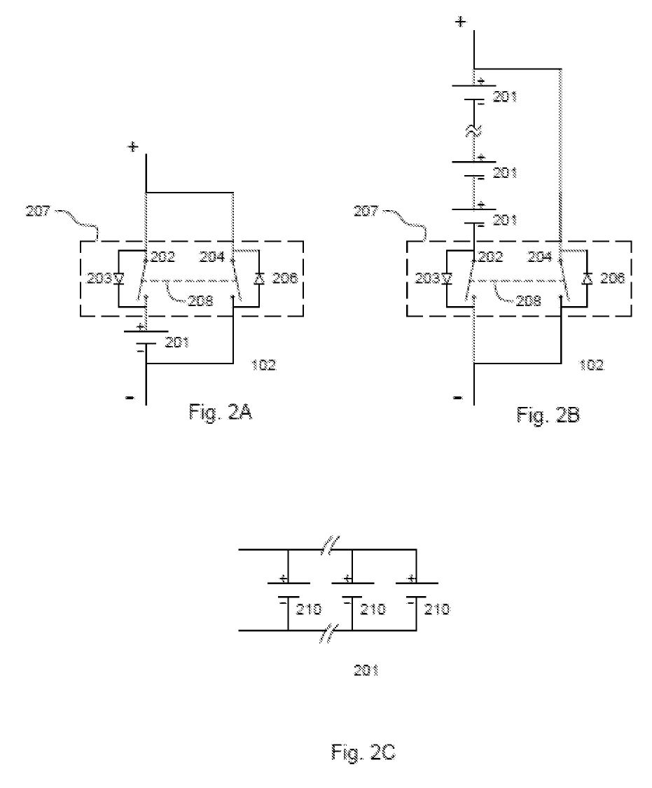

FIG. 1 shows an embodiment of an ABS 100 composed of a plurality of ESB modules 102 which may range in number from 1 to “M” arranged in serial connections configured to provide power to load 113. As illustrated in FIG. 2A, each ESB module 102 may include at least one ESB assembly 201 or a plurality of ESB assemblies 201 which may range in number from 1 to “N” (as shown in FIG. 2B), typically be arranged in serial connections. Each ESB assembly 201 includes at least one single battery 210 or a plurality of individual batteries 210 which may range in number from 1 to “C” (as shown in FIG. 2C) and typically be arranged in parallel connections. As shown in FIG. 1, first DC power source 104 is configured to charge the ESB assembly 201 in the ESB modules 102. First DC power source 104 can be a battery charger (e.g., for an electric vehicle) or it can also be a High Voltage DC utility transmission power line. Arranged in series with DC power source 104 is first DC power source disconnect switch 116 which allows for a connection between the power source 104 and the ESB modules 102. The disconnect switch 116 is controlled by a central control unit 112 and may be closed to charge the ESB module 102. A plurality of battery management systems 106 are coupled to the ESB modules 102 to provide the ability to monitor battery characteristics such as the voltage or current of connected individual ESB modules 102. The battery management systems (BMS) are any electronic system that manages the rechargeable batteries 210 in the ESB assemblies 201 such as by protecting each of the batteries from operating outside its designed voltage and current, calculating secondary data, reporting that data to a control center unit 112, controlling its environment, authenticating it and/or balancing it. Such monitoring by the battery management systems 106 may help to maximize performance and/or reliability of the ESB modules 102. Each battery management system 106 may be equipped with an integrated circuit that measures battery voltage and communicates that information onto a wireless or wired communication link (or system) 110. The communication link 110 communicates between the battery management systems 106 and the central control unit 112. For a high voltage DC application, optically isolated wired communication is optimal. FIG. 1 shows communication links 110 for illustration of wired communication only. The switching command of disconnect switch 116 and battery monitoring communication 110 can be wired or wireless.

The plurality of energy storage batteries 210 are rechargeable batteries and may be lithium batteries (e.g., Lithium Iron Phosphor (LiFePO4), Lithium Cobalt Oxide (LiCoO2), Lithium Manganese Oxide (LiMn2O4)), Lithium iron phosphate (LFeP), Lithium Nickel Manganese Cobalt Oxide (NMC), Lithium Nickel Cobalt Aluminum Oxide (NCA), Lithium Titanate (LTO) and Lithium Sulphur), lead acid batteries, nickel-metal hydride (NiMH) batteries, nickel-zinc (NiZn) batteries, silver-zinc (AgZn) batteries, and aluminum-ion batteries.

The active battery stack 100 may be used as a high voltage DC connect/disconnect switch as illustrated in FIG. 1. In operation, while the plurality of ESB modules 102 in the stack are engaged to match the load 113 electric potential to first DC power source 104 electric potential, switch 116 can be closed without electric arcing. In such application the battery stack 100 may only need minimum current capacity to support a connecting moment.

FIG. 2A shows details of an exemplary ESB module 102 comprising Electronic Connection Device (ECD) 207 coupled with at least one ESB assembly 201 (as shown in FIG. 2A) or a plurality of ESB assemblies 201 (as shown in FIG. 2B). ECD 207 may be an electronic half bridge with a bypass diode which enables the ESB assembly 201 to engage and disengage from the ABS 100. The ECD 207 has a first switch 202 serially connected with ESB assembly 201 and second switch 204 in a parallel arrangement. Each of the switches 202, 204 are coupled with bypass diodes 203, 206. A bypass diode lets current go only in one direction while the switch is electrically disconnected. Both switches 203, 204 can be mechanical relays or solid state switches such as metal-oxide-semiconductor field effect transistors (MOSFET), insulated gate bipolar transistors (IGBT), integrated gate-commutated thyristors (IGCT), MOSFET-controlled thyristor (MCT) or other switchable devices. First bypass diode 203 is coupled with first switch 202 and second bypass diode 206 is coupled with second switch 204. As will be discussed herein, the dotted line 208 in FIGS. 2A and 2B indicates that switches 202 and 204 work substantially synchronously. In operation, only one of the first and second switches (202 or 204) closes at any time or in other words the two switches never close at the same time since to close both switches at the same time would short circuit the ESB assembly 201. However at the switching instance both switches 202 and 204 are open or electrically not conductive and it is electrical dead time for the ECD 207. At this dead time moment, the bypass diodes 203, 206 will let current pass through.

FIG. 2B shows details of an exemplary ESB module 102 comprising Electronic Connection Device (ECD) 207 coupled with a plurality of ESB assemblies 201. Switch 202 of the ECD 207 is serially connected to the “lower” side of ESB assembly 201.

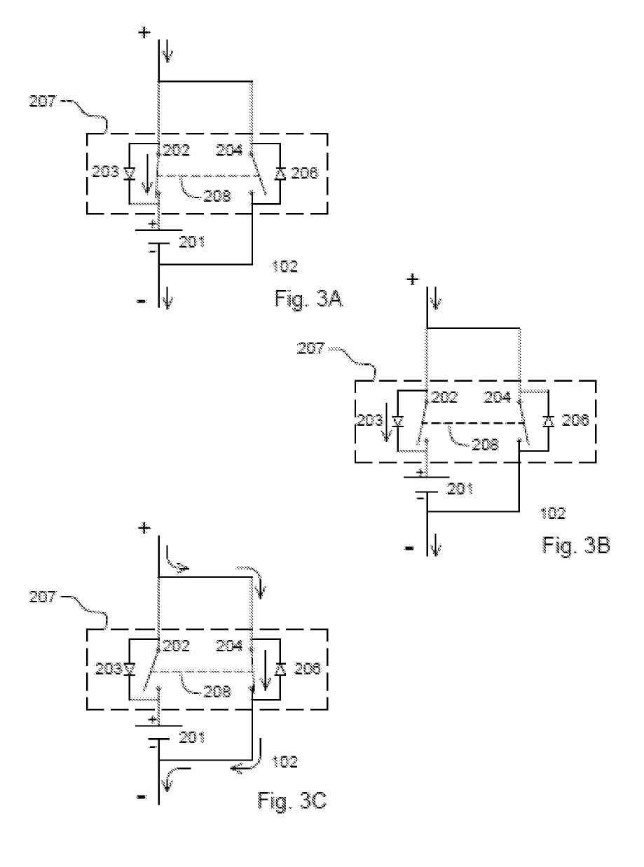

FIG. 3A shows operation of the ABS 100 with ESB module 102 engaging under charging conditions with the first switch 202 electrically connected and the second switch 204 electrically disconnected. ESB assembly 201 is under charging and arrows show the current flow path in the ECD 207. FIG. 3B shows ESB module 102 at a switching instance with switches 202 and 204 open and continued current flow through bypass diode 203 in the ECD 207 while ESB module 102 is disengaging. FIG. 3C shows ESB module 102 disengaged under charging conditions, the first switch 202 is electrically disconnected and the second switch 204 is electrically connected. The ESB assembly 201 is disengaged when fully charged or is needed to be pulled out of the battery stack for maintenance or replacement. The switches 202 and 204 may be operationally controlled by control unit 112.

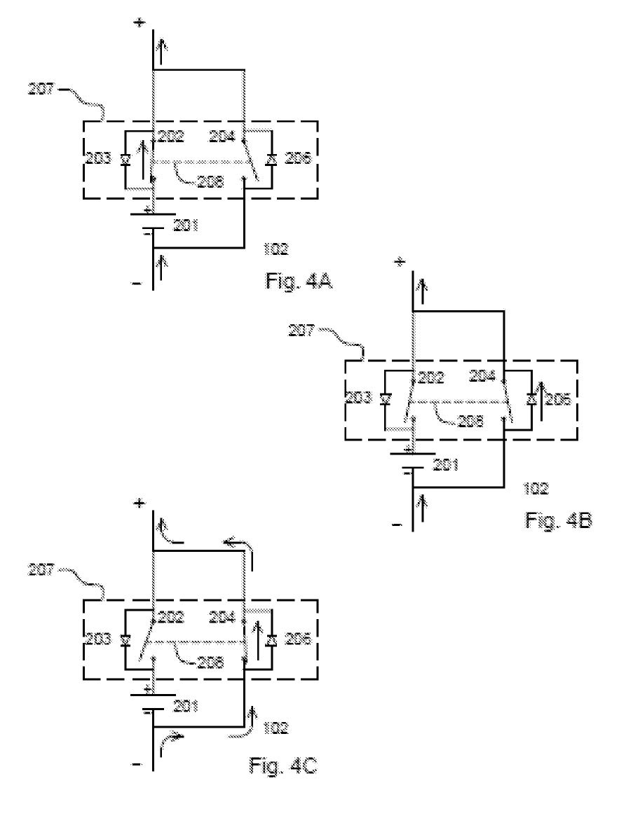

FIG. 4A shows operation of ABS 100 with ESB module 102 engaging under discharging conditions with the first switch 202 is electrically connected and the second switch 204 is electrically disconnected. ESB assembly 201 is under discharging and arrows show the current flow path in the ECD 207. FIG. 4B shows ESB module 102 at a switching instance with switches 202 and 204 open and continued current flow through bypass diode 206 in the ECD 207 while ESB module 102 is disengaging. FIG. 4C shows ESB module 102 disengaged under discharging conditions, the first switch 202 is electrically disconnected and the second switch 204 is electrically connected. The ESB assembly 201 is disengaged when fully discharged or is needed to be pulled out of the battery stack for maintenance or replacement. The switches 202 and 204 may be operationally controlled by control unit 112.

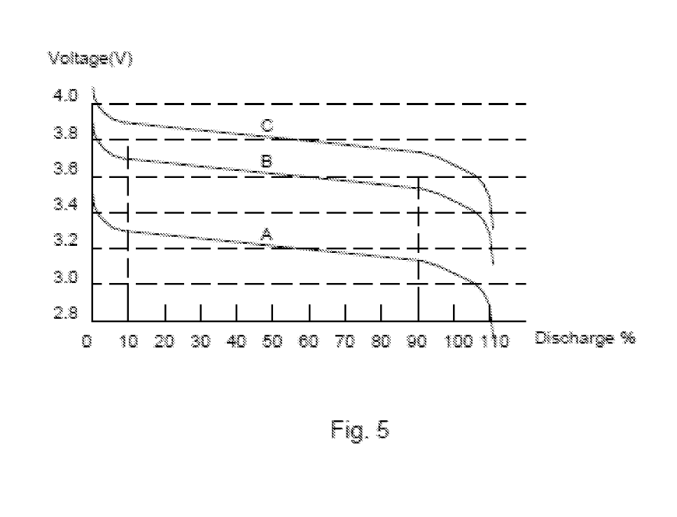

FIG. 5 shows typical lithium battery voltage characteristics verses discharged capacity under “1C” discharging conditions for different types of batteries 210 where 1C is the discharging current to fully discharge the battery in one hour. For example, if a 50 ampere-hour (AH) battery discharges at 50 Amps it will completely discharge the battery at 1C in one hour. Line A represents a Lithium Iron Phosphor battery (LiFePO4) with nominal cell voltage 3.2 Volts (V). Line B represents a Lithium Cobalt Oxide battery (LiCoO2) with nominal cell voltage 3.6V. Line C represents a Lithium Manganese Oxide battery (LiMn2O4) with nominal cell voltage 3.7V. The graphed lines show that within 10% to 90% charged capacity, the battery voltage stays in very narrow and very predictable voltage variation (i.e., it is substantially “constant”).

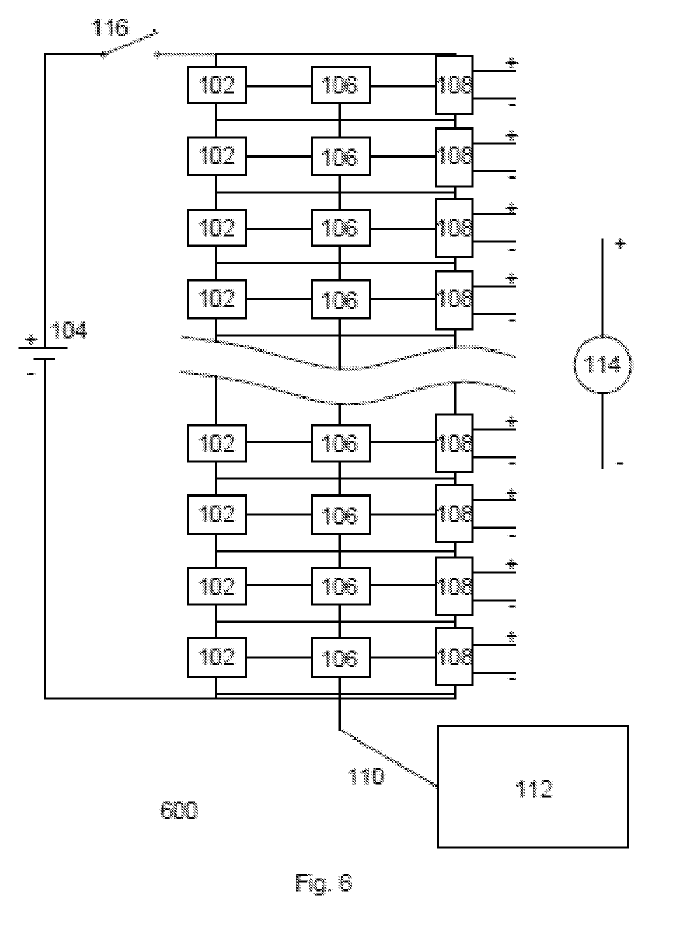

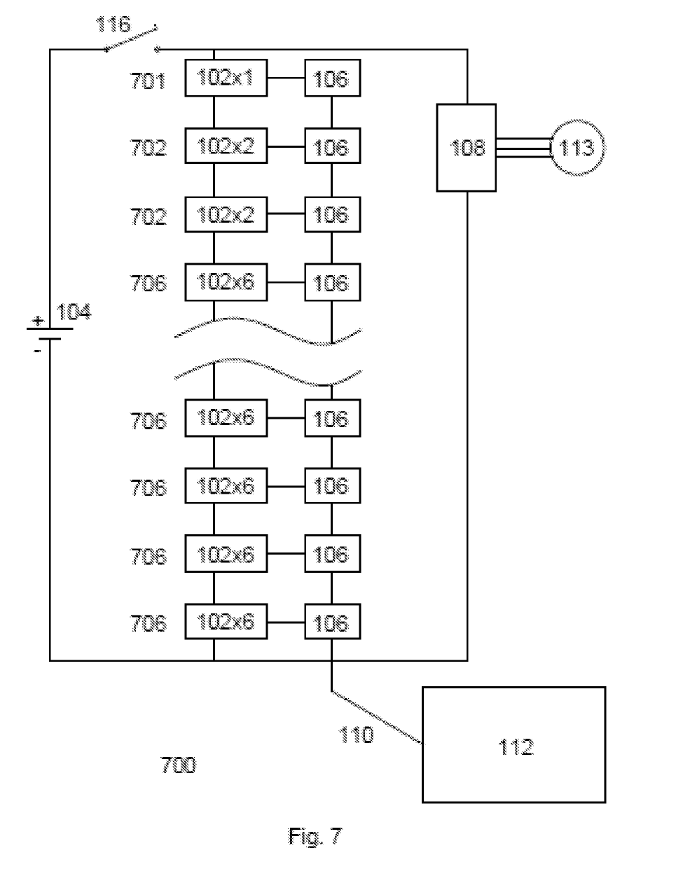

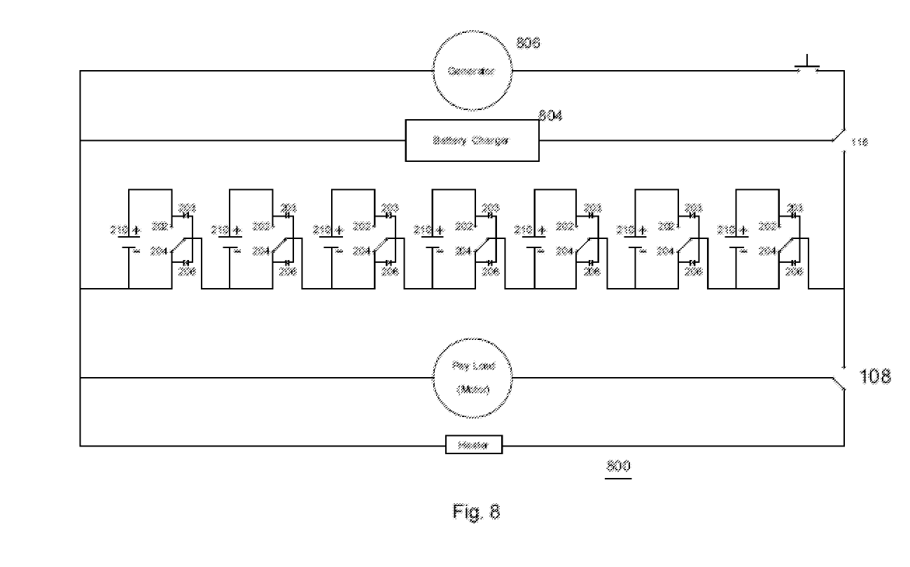

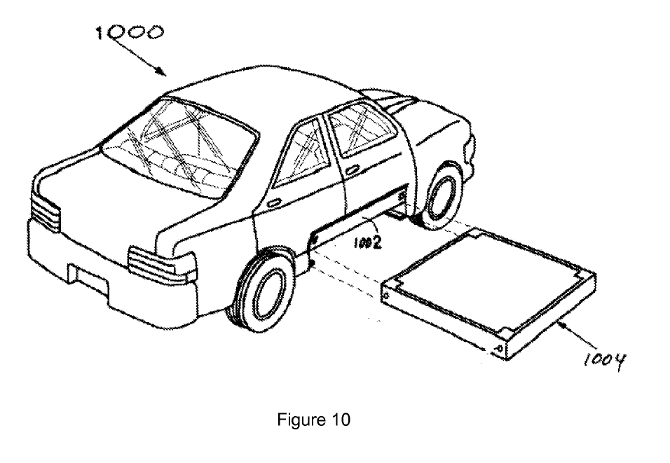

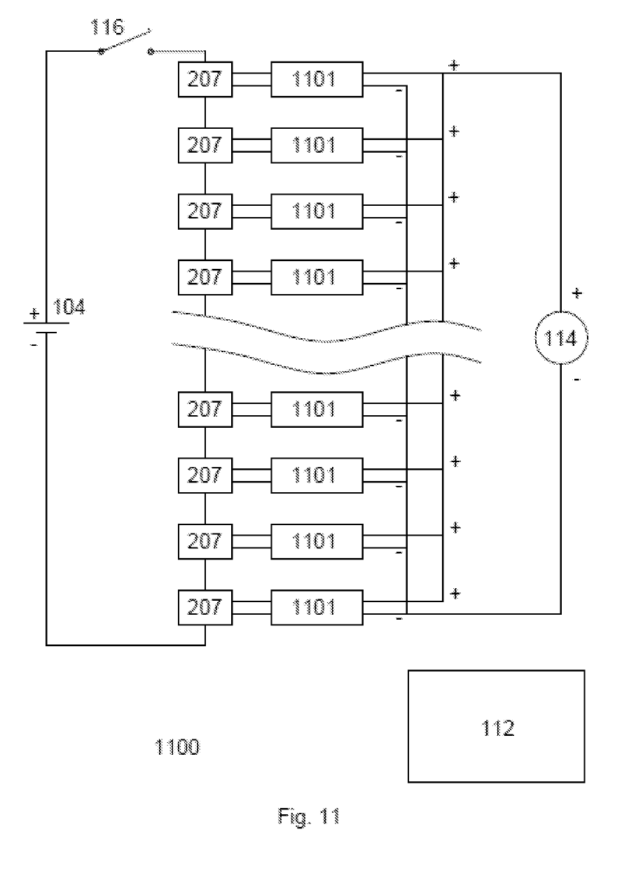

FIG. 6 shows an ABS 600 that may be used as a high DC voltage divider. Batteries 210 are fabricated to perform in a predetermined current and voltage range. Within their designed working range, a battery 210 is an energy storage device and also a super capacitor. A battery's open circuit voltage is directly associated with charged capacity and can be viewed as a “constant” within a specific voltage range in a given time. When stacks of ESB modules 102 are placed under the first DC power source 104, the stack charging current will depend on the voltage difference between the first power source minus the ABS 600 total voltage divided by the ABS 600 total internal resistance. By actively adding or subtracting ESB modules 102 in ABS 100, ABS 600, ABS 700 (as shown in FIG. 7), ABS 800 (as shown in FIG. 8), ABS 1004 (as shown in FIG. 10), and ABS system 1100 (as shown in FIG. 11) the stack charging or discharging current can be effectively controlled within a predetermined working range. Each ESB module 102 in the active battery stack 600 effectively acts as a voltage divider and the stack voltage is divided into energy storage battery ESB module 102 voltages. For example, the ESB modules 102 as voltage dividers may divide a high voltage direct current (HVDC) input (e.g, in the range of 5 kiloVolts (kV) to 1000 kV) into smaller predetermined voltage outputs (e.g., under 500V) such as the converters 108. There is basically no limit on how high the voltage in this battery stack 600 can go as long as the ESB modules 102 in the stack are working within a designated current. With each ESB module 102 effectively dividing the stack high voltage into ESB module 102 voltages, the ESB module 102 energy can be converted to a secondary DC power source by connected converters 108. A secondary output can be configured in parallel or serially to generate a desired second DC current and voltage. An AC inverter can be used further convert DC into AC. FIG. 6 only shows load 114 without the parallel or serial configuration is shown. In an alternative embodiment, the ESB module 102 voltage can be set at some where half of the full capacity for voltage stability and have spare storage capacity for an incoming power surge.

FIG. 7 shows an ABS 700 with a variety of different ESB 102 configurations. The designation 102×0 means the ESB module 102 has no ECD 207 coupled with ESB assembly 201. The designation 102×X means the ESB module 102 has ECD 207 coupled with “X” ESB assemblies 201. ESB module 701 comprises one ESB assembly 201; 702 includes two ESB assemblies 201; and ESB modules 706 includes six ESB assemblies 201 each. By actively engaging selected ESB modules, a discrete stack voltage can be generated from a single battery voltage (e.g., ESB module 701 102×1 engaged only) to full battery stack voltage with every ESB module engaged. An electric DC motor can be driven directly by stack current to control a DC motor torque. DC converter 108 is a PWM inverter or a DC commutator and may generate multiple second DC power to driver traction motor load 113. Battery charger 104 (e.g., electric vehicle charger) is a first DC power. Traction motor 113 and DC converter 108 also function together as first DC power at regeneration. Here each ESB module 102 has its own battery management system 106. Batteries 201 are fabricated to perform in predetermined current and voltage ranges. Charging batteries 201 over a specified voltage and current or discharging under its voltage range will inevitably deteriorate the battery performance and shorten battery service life. The active battery stacks 100, 600, 700, 800, 1004 and 1100 disclosed herein achieve optimal performance when each individual ESB module is charged to designed chargeable capacity and used up to the designed discharging voltage. Practically all battery stacks need serial connections to achieve the required voltage on any battery stack system including electric vehicles. In practice, a serially hard wired passively managed battery stack is only as strong as the weakest battery. During discharging, the weakest energy storage battery is first depleted to protect the weakest energy storage battery from over depleting and the stack having to shut down. While charging the serially hard wired battery stack, the weakest battery will be fully charged first, to prevent over charging the weakest battery and the stack have to stop charging. The full stress on the weakest battery in the serially hard wired battery stack puts stress on the weakest battery and diminishes the usable capacity and life span of the entire serially wired battery stack causing early replacement of the entire battery stack. However with an ABS 100, 600, 700, 1104 or 1100 all the energy storage batteries 201 are under equal stress and substantially all their capacity is used. While charging, a energy storage battery is only engaged in charging if energy storage battery voltage is under a maximum allowable operation voltage. While discharging, energy storage battery is typically only engaged if the energy storage battery voltage is above a minimum allowable operation voltage.

FIG. 8 is a diagram of an exemplary implementation of the ABS 800. Battery charger 804 and generator 806 provide power for charging batteries 210. This implementation uses: 1) single pull double throw (SPDT) relays to act as ECD 207's switch 202, 204 and 1 N4001 was used as bypass diodes 203, 206; 2) seven 18650 Li-ion energy storage batteries 210; 3) a Canon PA-08J 12VDC power supply as a first DC power 104; 4) an Arduino Mega MCU board is used as Battery Management system, communication and control 106,110,112; 5) the motor 109 used is from a Sherwood ST875 turntable; and 6) DC converter 108 is an on/off switch. Battery voltage is measured by analog inputs. A Nokia ACP-12U 5.7 VDC power supply was used to power the Arduino Mega control board. The Pay Load (or Motor) or heater receive power from the batteries 210.

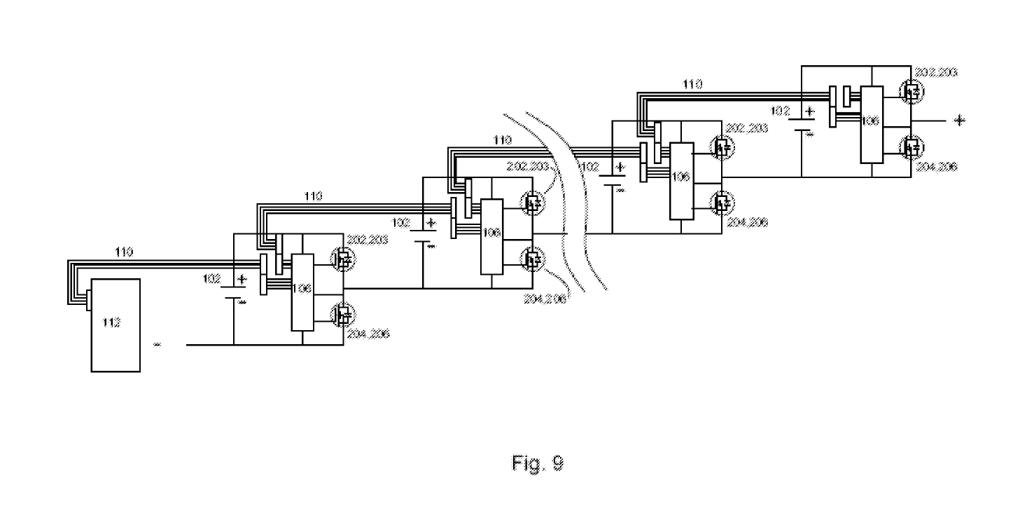

FIG. 9 illustrates an exemplary embodiment to utilize the ABS 700 as a Power on Demand Direct Drive for an electric vehicle DC traction motor configured as one 102×6, two 102×2 and one 102×1. Switches 202 and 204 and diodes 203 and 206 are Infineon MOSFET BTS7960 half bridge with body diodes. Batteries 210 used are 12 serially connected 72 AH Li-ion-Iron-Phosphor battery. Each ESB assembly 201 has one Atmel AtMega328 and supporting components as battery management. Communications are wireless. Power supply 104 used is one retrofitted generics PC power supply to supply 360V DC to the stack.

FIG. 10 shows the active battery stack system and method disclosed herein used in an electric vehicle 1000. Electric vehicle 1000 includes a chassis defining a battery compartment 1002 for receiving an active battery stack 1004 therein. The electric vehicle 1000 further includes components such as, an electric motor, a drive train including a transmission, wheels, a body, a suspension system, a braking system, a steering system, seats, interior amenities, and the like. These components are mounted to the chassis and connected to form the electric vehicle 1000. In this case, the ABS 1004 would typically be mounted in the battery compartment 1002 when connected to a power source 104 (as shown in FIG. 1) for charging.

FIG. 11 shows the active battery stack system and method 1100 disclosed herein used in High Voltage Direct Current voltage conversion. Power conversion module 1101 comprises an ESB assembly (or ESB assemblies) 201, battery management system 106 and isolated switching DC-DC converter 108. Power conversion module 1101 is coupled with serially connected Electrical Connection Devices 207. Control center 112 controls ECD 207 engaging or disengaging wirelessly through link 110. Power conversion module 1101 can be decommissioned while ECD 207 is disengaged.

Some or all of the embodiments disclosed herein may offer the following benefits. First, an alternative method for High Voltage DC voltage step down is disclosed by using solid state semiconductor technology. Second, there is disclosed an alternative method to build High Voltage DC voltage breakers or connection switches. Third, the embodiments of this disclosure may be an integrated battery backup system into power supply for some applications with critical requirements such as data center reducing power backup cost. Fourth, the embodiments disclosed herein allow over charged battery or over discharged battery to disengage from the battery stack without affecting the system function. Fifth, the embodiments of this disclosure enable Voltage or Power on Demand (POD) by engaging batteries sequentially to build up stack voltage so as to be used as a DC power breaker to connect or disconnect the second to the first DC power source. Sixth, the embodiments disclosed herein allow more frequent use of healthier batteries to extend pack service life. Seventh, the embodiments disclosed herein prevent the overstressing of weaker batteries. All ESB modules are able to be used to their maximum designed usable capacity without overstressing any weak ESB module. Weak ESB modules can be disengaged from the battery stack when they reach a low voltage point. Eighth, the embodiments disclosed herein are especially helpful for electric vehicle applications. By using each battery to maximum usable capacity, the active battery stack has a longer range or will use less battery for the same range. Ninth, the embodiments disclosed herein are also safer than passive battery management systems which are normally only present at battery-level voltage whereas stack full voltage is only present when every single battery in the stack is in engaged mode.

Uses of the active battery stack system and method disclosed herein may include, but are not limited to, utility high voltage DC (HVDC) power transmission voltage conversion, HVDC circuit breaker disconnect switch, data server centers, high voltage electric traction motor voltage conversion including electric vehicle battery stack systems, power tools, and portable electronic devices such as phones, computers, mobile phones, and mobile tablets.

The foregoing described embodiments have been presented for purposes of illustration and description and are not intended to be exhaustive or limiting in any sense. Alterations and modifications may be made to the embodiments disclosed herein without departing from the spirit and scope of the invention. No language in the specification should be construed as indicating any non-claimed element as essential to the practice of the invention. The actual scope of the invention is to be defined by the claims.

The definitions of the words or elements of the claims shall include not only the combination of elements which are literally set forth, but all equivalent structure, material or acts for performing substantially the same function in substantially the same way to obtain substantially the same result.

All references, including publications, patent applications, patents and website content cited herein are hereby incorporated by reference to the same extent as if each reference were individually and specifically indicated to be incorporated by reference and was set forth in its entirety herein.

The words used in this specification to describe the invention and its various embodiments are to be understood not only in the sense of their commonly defined meanings, but to include by special definition in this specification any structure, material or acts beyond the scope of the commonly defined meanings. Thus if an element can be understood in the context of this specification as including more than one meaning, then its use in a claim must be understood as being generic to all possible meanings supported by the specification and by the word itself.

Recitation of ranges of values herein are merely intended to serve as a shorthand method of referring individually to each separate value falling within the range, unless otherwise indicated herein, and each separate value is incorporated into the specification as if it were individually recited herein. Therefore, any given numerical range shall include whole and fractions of numbers within the range. For example, the range “1 to 10” shall be interpreted to specifically include whole numbers between 1 and 10 (e.g., 1, 2, 3, . . . 9) and non-whole numbers (e.g., 1.1, 1.2, . . . 1.9).

Neither the Title (set forth at the beginning of the first page of the present application) nor the Abstract (set forth at the end of the present application) is to be taken as limiting in any way as the scope of the disclosed invention(s). The title of the present application and headings of sections provided in the present application are for convenience only, and are not to be taken as limiting the disclosure in any way.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data or power most of the time. In addition, devices that are in communication with or coupled with each other may communicate directly or indirectly through one or more intermediaries.

Although process (or method) steps may be described or claimed in a particular sequential order, such processes may be configured to work in different orders. In other words, any sequence or order of steps that may be explicitly described or claimed does not necessarily indicate a requirement that the steps be performed in that order unless specifically indicated. Further, some steps may be performed simultaneously despite being described or implied as occurring non-simultaneously (e.g., because one step is described after the other step) unless specifically indicated. Where a process is described in an embodiment the process may operate without any user intervention.

1. An active battery stack (ABS) Direct Current (DC) energy storage system, comprising:
a plurality of energy storage batteries in a battery stack; and
at least one electrical connection device coupled to at least one of the plurality of energy storage batteries, wherein the at least one electrical connection device comprises a first switch serially connected with the at least one of the plurality of energy storage batteries and a second switch connected in parallel with both of the at least one of the plurality of energy storage batteries and the first switch.

2. The system of claim 1, wherein the plurality of energy storage batteries and the at least one electrical connection device are formed into an energy storage battery module which is coupled to at least one battery management system.

3. The system of 1, wherein the plurality of energy storage batteries are configured in a parallel electrical connection to build up current capacity in the battery stack.

4. The system of claim 1, wherein the plurality of energy storage batteries are configured in a series electrical connection to build up voltage in the battery stack.

5. The system of claim 1, wherein the plurality of energy storage batteries are configured to receive charge from a first DC power source.

6. The system of claim 1, wherein the plurality of energy storage batteries is from the group consisting of: lithium ion batteries, lead acid batteries, nickel-metal hydride (NiMH) batteries, nickel-zinc (NiZn) batteries, silver-zinc (AgZn) batteries, and aluminum-ion batteries.

7. The system of claim 1, wherein the first switch includes a first bypass diode and the second switch includes a second bypass diode.

8. The system of claim 7, wherein the first and second bypass diodes are configured to allow current in the battery stack to continuously pass through the electrical connect device at moments when the first and second switches are open.

9. The system of claim 1, wherein the first switch and second switch are from a group consisting of: mechanical switches, solid-state switches, mechanical disconnect switch, Single Pole Double Throw switch, relay, metal-oxide-semiconductor field effect transistors (MOSFET), insulated gate bipolar transistors (IGBT), integrated gate-commutated thyristors (IGCT), and MOSFET-controlled thyristor (MCT).

10. The system of claim 1, wherein the system is used in one from the group consisting of: a utility HVDC power transmission voltage conversion, HVDC circuit breaker disconnect switch, a data server center, a high voltage electric traction motor voltage conversion, an electric vehicle active battery stack system, a power tool, and a portable electronic device.

11. The system of claim 2, further comprising:
a battery management system coupled to the energy storage battery module to monitor the voltage of the plurality of energy storage batteries; and
a communication system which communicates between the battery management system and a central control unit.

12. A method to build up a battery stack including a plurality of energy storage battery (ESB) modules with a variable stack voltage by engaging and disengaging the plurality of ESB modules.

13. The method of claim 12, wherein each of said ESB modules includes a plurality of energy storage batteries in a battery stack and at least one electrical connection device coupled to at least one of the plurality of energy storage batteries, said at least one electrical connection device configured to engage and disengage the plurality of ESB modules by closing and opening a first switch and a second switch in the at least one electrical connection device.

14. The method of claim 13, wherein the first switch is serially connected to at least one of the plurality of energy storage batteries and the second switch is in parallel with the first switch.

15. The method of claim 13, wherein the method is used in one from the group consisting of: a utility HVDC power transmission voltage conversion, HVDC circuit breaker disconnect switch, a data server center, a high voltage electric traction motor voltage conversion, an electric vehicle active battery stack system, a power tool, and a portable electronic device.

16. The method of claim 13, wherein the first switch includes a first bypass diode and the second switch includes a second bypass diode which are configured to allow current in the battery stack to continuously pass through the electrical connect device at moments when the first and second switches are open.

17. The method of claim 12, wherein the plurality of energy storage batteries are configured in a parallel electrical connection to build up current capacity in the battery stack.

18. The method of claim 12, wherein the plurality of energy storage batteries are configured in a series electrical connection to build up voltage in the battery stack.

19. A method in a battery stack to use a plurality of energy storage battery (ESB) modules as voltage dividers to divide a high voltage direct current (HVDC) input into lower predetermined voltage outputs.

20. The method of claim 14, wherein the HVDC input is stepped down from a range of 5 kiloVolts (kV) to 1000 kV to under 500V at each of the outputs.
